(19) United States
(12) Patent Application Publication
(10) Pub. No.: US 2022/0152710 A1
(43) Pub. Date: May 19, 2022

(54) HYDRAULIC EXPANDING CHUCK

(71) Applicant: Guehring KG, Albstadt (DE)

(72) Inventor: Klaus MATHEIS, Sauldorf/Rast (DE)

(73) Assignee: Guehring KG, Albstadt (DE)

(21) Appl. No.: 17/645,823

(22) Filed: Dec. 23, 2021

Related U.S. Application Data
(63) Continuation of application No. PCT/EP2020/066864, filed on Jun. 18, 2020.

(30) Foreign Application Priority Data
Jul. 3, 2019 (DE) 10 2019 209 732.4

(51) Int. Cl. B23B 31/117; B23B 31/00

(52) U.S. Cl. CPC B23B 31/1178; B23B 31/305; B23B 31/005

(57) ABSTRACT

A hydraulic expanding chuck having a main body which extends along a rotational axis and has a clamping part for receiving and clamping a shank tool and a shank part having a hollow shank for directly or indirectly coupling the hydraulic expanding chuck to a module of a modular tool system or to a machine spindle. The clamping part has a central receiving opening and, around the receiving opening, at least one pressure chamber to which fluid pressure can be applied and which is separated from the receiving opening via an elastically yielding expansion wall and is connected via a pressure duct to a pressure-generating device situated in the main body. The pressure-generating device is arranged axially in the region between the receiving opening and the hollow shank in a central cut-out, which is coaxial with the receiving opening and which opens into the hollow shank.

The invention relates to a hydraulic expansion chuck according to the preamble of claim 1.

Hydraulic expansion chucks of this type are known, for example, from WO 2017/093280 A1, DE 102012215036 A1, DE 10312743, DE 102012110392 B4, or WO 2015/166062 A1, and have a base body, which extends along a rotational or longitudinal central axis and which can be functionally divided into a clamping part for receiving and clamping a shaft tool and a shaft part. Around a central receiving opening, the clamping part has at least one pressure chamber, to which fluid pressure can be applied and which is separated from the receiving opening via an elastically resilient expansion wall and which is connected via a pressure duct to a pressure generating means arranged in the base body. The expansion wall bulges against a shaft tool, e.g. drill or milling tool, which is received in the central receiving opening, during a fluid pressure application of the at least one pressure chamber, in order to clamp the shaft tool, which is received in the central receiving opening, in a non-positive manner. To unclamp the shaft tool, the fluid pressure in the at least one pressure chamber is decreased. To regulate the fluid pressure in the at least one pressure chamber, the known hydraulic expansion chucks routinely have a pressure generating means in the form of a piston clamping mechanism comprising a pressure and sealing body, which sits in a bore in the clamping part and which limits a pressure generating chamber, a piston sitting in the bore, which pushes the pressure and sealing body against the pressure generating chamber, and an adjusting screw, which displaces the piston and which sits in a threaded bore, which axially connects to the bore. The threaded bore leads to the outer jacket surface of the clamping part, so that the adjusting screw can be actuated from laterally outside of the clamping part. The pressure generating chamber is connected to the at least one pressure chamber via the pressure duct.

The pressure generating means constructed in this way is arranged in the base body in such a way that it extends from radially on the outside to radially on the inside transversely to the rotational or longitudinal central axis of the base body.

The arrangement of the pressure generating means, which lies radially offset from the rotational or longitudinal central axis, results in an asymmetric cross section design of the base body and thus in an uneven mass distribution about the rotational or longitudinal central axis, and in an imbalance when using the hydraulic expansion chuck. To keep imbalance-related concentricity errors of a clamped shaft tool as low as possible, the known hydraulic expansion chucks are routinely balanced prior to the first use. Depending on the required balancing quality or extent of the imbalance, the balancing process can be very complex.

Based on a generic hydraulic expansion chuck, the invention is thus based on the object of providing an imbalance-reduced hydraulic expansion chuck.

This object is solved by means of a hydraulic expansion chuck comprising the features of claim 1. Advantageous or preferred further developments are subject matter of dependent claims.

The hydraulic expansion chuck according to the invention comprises a base body, which extends along a rotational or longitudinal central axis and which has a clamping part for receiving and clamping a shaft tool, e.g. drill or milling tool, and a shaft part comprising a hollow shaft for directly or indirectly coupling the hydraulic expansion chuck to a module of a modular tool system or to a machine spindle. The clamping part has an axially running central receiving opening and, around the receiving opening, at least one pressure chamber, to which fluid pressure can be applied. The at least one pressure chamber is separated from the receiving opening by means of an elastically resilient expansion wall. The expansion wall bulges against a shaft tool, which is received in the central receiving opening, during a fluid pressure application of the at least one pressure chamber, in order to clamp the shaft tool, which is received in the central receiving opening, in a non-positive manner. The at least one pressure chamber can be formed in the form of a ring surrounding the receiving opening and can comprise one or several pressure chambers, which are formed in an axially separated manner and which are fluidically connected to one another. In a preferred embodiment, the hydraulic expansion chuck has two pressure chambers, which are formed in a ring-shaped manner and which are connected to one another via one or several eccentrically lying connecting ducts. In any case, the at least one pressure chamber is connected to a pressure generating means arranged in the base body via a pressure duct.

Axially in the region between the receiving opening and the hollow shaft ,the pressure generating means, according to the invention, is arranged in a central recess, which is coaxial to the receiving opening and which leads into the hollow shaft, and can be actuated through the hollow shaft, in contrast to the above-discussed generic hydraulic expansion chucks. The pressure generating means therefore has a direction of extension, which corresponds to the direction of the rotational or longitudinal central axis. By means of the central arrangement according to the invention of the pressure generating means, an imbalance of the hydraulic expansion chuck, which is caused by the pressure generating means, can be reduced significantly, because a more even mass distribution around the rotational or longitudinal central axis of the hydraulic expansion chuck can be attained by means of the central arrangement according to the invention, in the case of which the main axes of inertia, respectively, of the base body and of the pressure generating means lie at least in the vicinity of the rotational or longitudinal central axis. Due to the axial extension of the pressure generating means, the radial expansion of the base body can furthermore be kept smaller than in the case of the known hydraulic expansion chucks. According to the invention, the pressure generating means can furthermore be actuated through the hollow shaft. The pressure generating means can be accessed through the open hollow shaft of the shaft part, which faces away from the clamping part.

For this purpose, the hollow shaft can be formed, for example, as a hollow shaft taper (HSK), steep taper (SK), or cylinder shaft, which is known to the person of skill in the art.

In a preferred embodiment, the preferably cylindrical recess is fluidically separated from the receiving opening. The recess can be formed, for example, from an axial blind hole bore, which extends from the hollow shaft in the direction of the clamping part and which ends axially in front of the receiving opening. In the region of the base, the pressure duct can lead into the blind hole bore in this case.

To generate a fluid pressure in the pressure duct, the pressure generating means can furthermore have a piston mechanism comprising a piston, which is arranged in an axially displaceable manner in the recess, and a screw body, which displaces the piston and which is axially screw-connected to the base body and can be actuated through the hollow shaft. In this case, the piston can limit a pressure generating chamber in the region of the base, into which the pressure duct leads.

A sealing body, which sits in the recess in an accurately fitting manner, made of an elastic material, e.g. rubber or high-strength plastic, can be assigned to the piston.

The screw body can be, for example, an adjusting screw, which is screwed into a threaded bore, which axially elongates the central recess and which acts indirectly or directly on the piston. The threaded bore, in which the screw body sits, can be formed in the shaft part, while at least that longitudinal portion of the central recess, in which the piston and optionally the sealing body sit and in which the pressure generating chamber lies, can be formed in the clamping part. The formation of the threaded bore in the shaft part and of the recess in the clamping part is advantageous in particular when the shaft part and the clamping part are formed from bodies, which are initially fabricated separately and which are then axially joined together by means of a positive connection, non-positive connection, and/or substance-to-substance bond. In particular the clamping part, which, with the at least one pressure chamber, the pressure duct, and at least a part of the central recess, has more complicated hollow structures, can be additively manufactured by means of 3D printing, while the shaft part, which, with the hollow shaft, the threaded bore, and optionally a part of the central recess, has simpler hollow structures, can be made in the conventional way, e.g. by means of machining of a metallic body in this case. In the alternative, the base body of the hydraulic expansion chuck as a whole can be constructed monolithically, e.g., by means of additive manufacture.

Unintentional interactions between the piston possible irregularities at the contact point between shaft part and clamping part can be avoided at the same time. Due to the fact that that length portion of the central recess, in which the pressure limiting chamber lies and in which the pressure fluid is located, lies outside of the contact point, an additional sealing at the contact point can be forgone.

The separate manufacture of the clamping part and shaft part furthermore provides for a modularized setup of the clamping chuck and therefore for a broader application spectrum because a suitable clamping part can be combined with a suitable shaft part in order to produce the clamping chuck.

For a rotationally fixed, axial connection, the clamping part and shaft part are joined together in a positive manner, non-positive manner, and/or by means of a substance-to-substance bond. A non-positive joining can be attained, e.g., by means of screw-connection, clamping, or the like, which can be realized easily from a technical aspect and which ensures a connection, which is stable and which can be detached gain at the same time. A substance-to-substance bond is attained, e.g., by means of welding, soldering, or adhering.

To ensure a high strength and long service life as well as a high concentricity of the components, the entire clamping chuck can be formed monolithically, e.g. by means of additive manufacture.

In the manner, which is known per se to the person of skill in the art, the hydraulic expansion chuck can further have a ventilation duct, which connects the at least one pressure chamber to a ventilation means. The ventilation means serves the purpose of ventilating the pressure fluid system, which is formed from the pressure chamber, the pressure duct, the central recess, etc., after a first or new filling, and will be or is, respectively, hermetically sealed to the outside after the filling.

For the above-described reasons, the mentioned ventilation means can be formed with the ventilation duct in the clamping part. In order to keep design-related imbalances as low as possible, it can be advantageous when the ventilation duct and the pressure duct lie offset to one another by 180° with respect to the rotational or longitudinal central axis.

The invention will be described below on the basis of the enclosed drawings, whereby

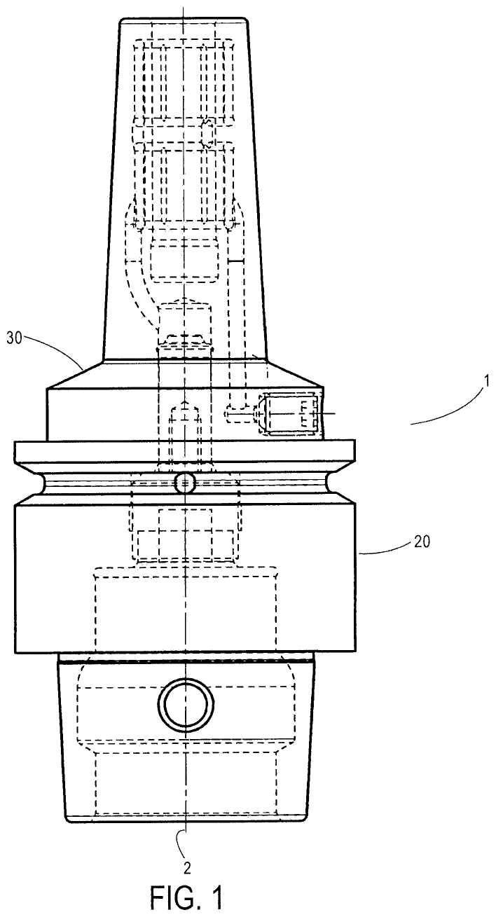

FIG. 1 shows a side view of the hydraulic expansion chuck according to the invention;

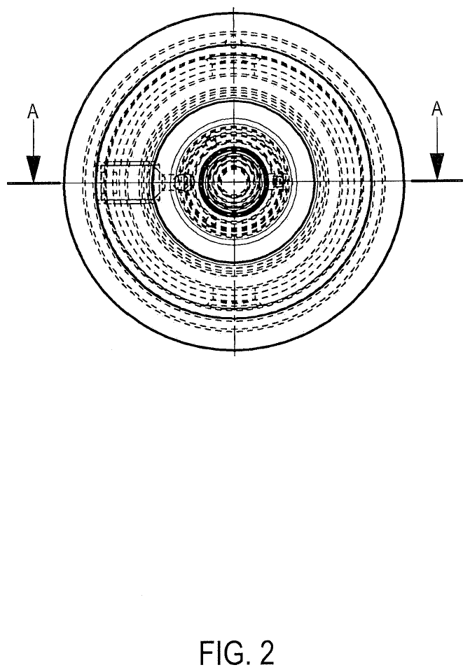

FIG. 2 shows a front-side top view of the hydraulic expansion chuck according to the invention;

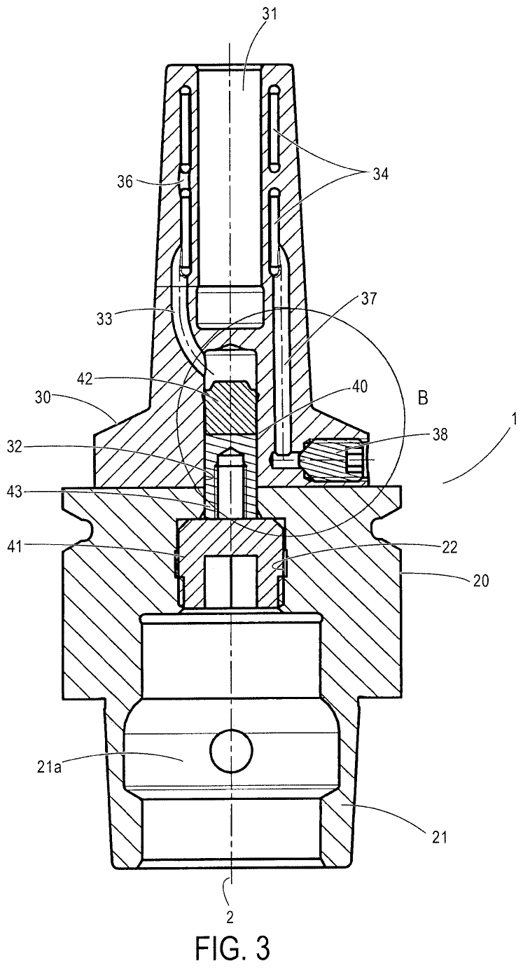

FIG. 3 shows a longitudinal section of the hydraulic expansion chuck according to the invention along a line A-A in FIG. 2; and

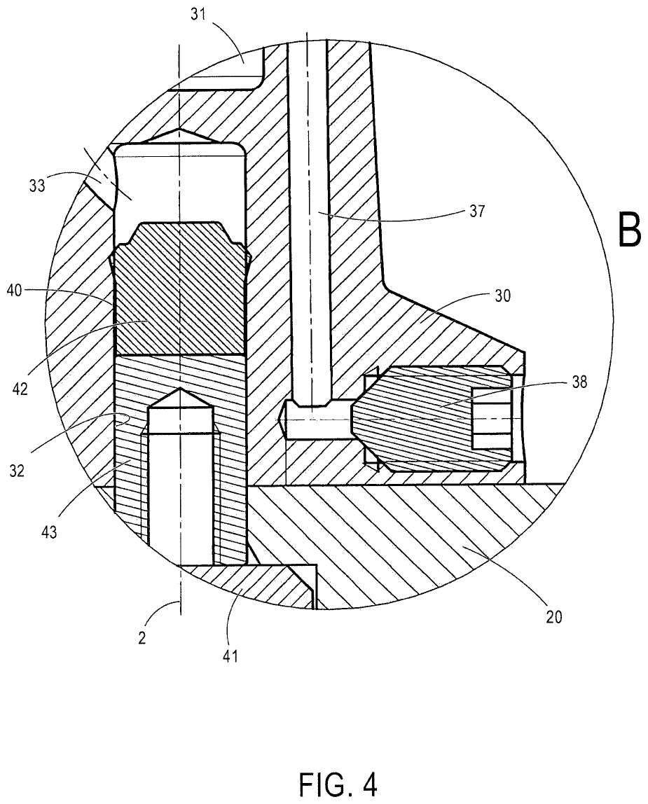

FIG. 4 shows an enlarged view of a region B, which is encircled in FIG. 3, of the hydraulic expansion chuck according to the invention;

FIGS. 1 to 4 show a preferred embodiment of a hydraulic expansion chuck according to the invention.

A hydraulic expansion chuck according to the invention has a base body 1, which extends along a rotational or longitudinal central axis 2 and which can be functionally divided into a shaft part 20 and a clamping part 30.

The shaft part 20 is provided to connect the base body 1 to a (non-illustrated) separating point (within a tool system) or an interface (direct reception in the case of a machine spindle) on a side facing away from the clamping part 30. For such a connection, the shaft part 20 has a hollow shaft 21 as shown in FIG. 3 on the side facing away from the clamping part 30. In the preferred embodiment, the shaft is formed by an HSK shaft, which is known per se to a person of skill in the art.

As can be seen in FIG. 3, the hollow shaft 21 has a centrally lying hollow space 21a, which is formed essentially rotationally symmetrical to the rotational or longitudinal central axis 2 and which is open towards the side facing away from the clamping part 30. The shaft part 20 furthermore has a central threaded bore 22, which extends along the rotational or longitudinal central axis 2, to which a central recess 32 in the form of a blind hole bore, which extends into the clamping part 30 along the rotational or longitudinal central axis 2, connects towards the clamping part 30.

A screw body 41 in the form of an adjusting screw, which displaces a piston 42, which will be described in more detail later and which sits in the central recess 32, in the direction of the clamping part 30, is screwed into the threaded bore 22.

In the preferred embodiment, as can be seen in FIG. 1 and FIG. 3, the shaft part 20 is formed so that, on its front side facing the clamping part 30, it is connected to the clamping part 30.

The clamping part 30 is provided for receiving and for clamping a (non-illustrated) shaft tool.

The clamping part 30 has a central receiving opening 31, which extends along the rotational or longitudinal central axis 2 and which is open on the front side facing away from the shaft part 20 and which receives and hydraulically clamps the shaft tool. As shown in FIG. 3, the central receiving opening 31 extends coaxially to the central recess 32 and to the threaded bore 22 in the shaft part 20. FIG. 3 furthermore shows that in the preferred embodiment, the central receiving opening 31 is spaced apart and thus fluidically separated from the central recess 32.

The above-mentioned central recess 32 or blind hole bore, respectively, extends from the shaft part 20 into the clamping part 30, as can be seen in FIG. 3.

In the region of the base, a pressure duct 33 leads into the blind hole bore. In the case of the preferred embodiment shown in the figures, the pressure duct 33 runs in an eccentrically curved manner to a pressure chamber assembly. In the preferred embodiment, the pressure chamber assembly comprises two pressure chambers 34, which revolve around the central receiving opening 31 in a ring-shaped manner and which are formed so as to be axially separated from one another and which are fluidically connected to one another via an eccentric connecting duct 36. As shown in FIG. 3, the pressure chambers 34 are in each case separated from the central receiving opening 31 by means of an elastically resilient expansion wall.

FIG. 3 furthermore shows an eccentric ventilation duct 37, which leads from the pressure chamber 34 to a ventilation means 38. In the preferred embodiment, the ventilation means 38 has a conical screw, which is screwed into a radially running threaded bore 22, comprising a conical front surface, which sits in an accurately fitting manner on a conical seat, in order to tightly seal the ventilation duct 37.

As can be seen from the different shadings in FIG. 3, the shaft part 20 and clamping part 30 were in each case initially fabricated separately from one another and were subsequently joined together in a rotationally and axially fixed manner in the shown embodiment. Concretely, the clamping part 30, which, with the two pressure chambers 34, the pressure duct 33, the ventilation duct 37, etc., has more complex hollow structures, was fabricated additively by means of 3D printing, while the shaft part 20, which, with the hollow shaft 21, the threaded bore 22, etc., has hollow structures, which can be realized more easily, was manufactures in a conventional manner by means of machining of a metallic body. For a rotationally fixed, axial connection, the clamping part 30 and shaft part 20 were subsequently joined together by means of welding, soldering, or the like by means of a substance-to-substance bond in the preferred embodiment.

The expansion walls bulge against the shaft tool, e.g. a drill or milling tool, which is received in the central receiving opening 31, during a fluid pressure application of the two pressure chambers 34, whereby the shaft tool is tensioned in a non-positive manner. To unclamp the shaft tool, the fluid pressure in the at least one pressure chamber 34 is decreased.

For the fluid pressure application of the two pressure chambers 34, the hydraulic expansion chuck according to the invention has a pressure generating means 40, which is described on the basis of FIG. 3 and FIG. 4. In the preferred embodiment, the pressure generating means 40 has a piston 42 mechanism comprising a piston 42, which is arranged in an axially displaceable manner in the central recess 32, and a screw body 41 in the form of an adjusting screw, which displaces the piston 42 and which is screwed into the above-mentioned threaded bore 22 through the hollow shaft 21. A sealing body 43, which sits in the central recess 32 in an accurately fitting manner, made of an elastic material, e.g. rubber or high-strength plastic, which limits a pressure generating chamber, which leads into the pressure duct 33, towards the base of the blind hole bore, is assigned to the piston 42, as is shown in FIG. 3.

If the adjusting screw is screwed into the threaded bore 22 towards the clamping part 30, the piston 42 is pushed with the sealing body 43 towards the base of the blind hole bore, whereby fluid is displaced from the pressure generating chamber into the pressure duct 33 and into the two pressure chambers 34. The pressure increase generated in the pressure chambers 34 effects a bulging of the expansion walls in the direction of the central receiving opening 31.

The ventilation means 38 serves for the ventilation of the fluid system after the first or new filling with fluid.

As shown in FIG. 3, the pressure generating means 40, according to the invention, is arranged axially in the region between the receiving opening 31 and the hollow shaft 21 in the central recess 32, which is coaxial to the receiving opening 31 and which leads into the hollow shaft 21, and can be actuated through the hollow shaft 21. The pressure generating means 40 therefore has a direction of extension, which corresponds to the direction of the rotational or longitudinal central axis 2. By means of the central arrangement according to the invention of the pressure generating means 40, an imbalance of the hydraulic expansion chuck, which is caused by the pressure generating means 40, can be reduced significantly, because a more even mass distribution around the rotational or longitudinal central axis 2 of the hydraulic expansion chuck can be attained due to the central arrangement according to the invention, in the case of which the main axes of inertia, respectively, of the base body 1 and of the pressure generating means 40 lie at least in the vicinity of the rotational or longitudinal central axis 2. By means of the axial extension of the pressure generating means 40, the radial expansion of the base body 1 can furthermore be kept small. According to the invention, the pressure generating means 40 can furthermore be actuated through the hollow shaft 21. The pressure generating means 40 can be accessed through the open hollow shaft 21 of the shaft part 20, which faces away from the clamping part 30.

Deviations from the above-described embodiment are possible within the scope of protection of the claims.

Instead of the two concentrically running pressure chambers 34 shown in FIG. 3, e.g., one, three, four, or more annularly concentrically running pressure chamber(s) can thus be present, or the pressure chambers can in each case be formed to be only partially circumferential.

The base body 1 as a whole can furthermore be manufactured monolithically.

The at least one pressure chamber 34 can be realized via a pivot bearing, which is axially inserted into the central receiving opening 31, as it is known, e.g., from DE 102012215036 A1.

Instead of a HSK shaft, the shaft part 20 can furthermore have, e.g., a steep taper shaft (SK), cylinder shaft, or another hollow shaft, which is likewise known to the person of skill in the art.

1 base body (hydraulic expansion chuck)

20 shaft part

21 hollow shaft

21a hollow space

22 threaded bore

30 clamping part

31 receiving opening

32 central recess

33 pressure duct

34 pressure chambers

36 connecting duct

37 ventilation duct

38 ventilation means

40 pressure generating means

41 screw body

42 piston

43 sealing body

1. A hydraulic expansion chuck comprising a base body, which extends along a rotational axis and which has a clamping part for receiving and clamping a shaft tool, and a shaft part comprising a hollow shaft for directly or indirectly coupling the hydraulic expansion chuck to a module of a modular tool system or to a machine spindle, wherein the clamping part has a central receiving opening and, around the receiving opening, at least one pressure chamber, to which fluid pressure can be applied and which is separated from the receiving opening via an elastically resilient expansion wall and which is connected via a pressure duct to a pressure generating means arranged in the base body,
axially in the region between the receiving opening and the hollow shaft, the pressure generating means is arranged in a central recess, which is coaxial to the receiving opening and which leads into the hollow shaft, and can be actuated through the hollow shaft.

2. The hydraulic expansion chuck according to claim 1, wherein the recess is fluidically separated from the receiving opening.

3. The hydraulic expansion chuck according to claim 1, wherein the pressure generating means comprises a piston mechanism comprising a piston, which is arranged in an axially displaceable manner in the central recess, and a screw body, which displaces the piston and which is axially screwed into the base body and can be actuated through the hollow shaft.

4. The hydraulic expansion chuck according to claim 3, wherein the screw body is formed from an adjusting screw, which is screwed into a threaded bore, which axially connects to the recess.

5. The hydraulic expansion chuck according to claim 4, wherein the threaded bore is formed in the shaft part.

6. The hydraulic expansion chuck according to claim 3, wherein a sealing body is assigned to the piston.

7. The hydraulic expansion chuck according to claim 1, wherein the at least one pressure chamber, the pressure duct, and at least a part of the central recess are formed in the clamping part.

8. The hydraulic expansion chuck according to claim 1, wherein the chuck further comprises a ventilation duct connecting the at least one pressure chamber to a ventilation means.

9. The hydraulic expansion chuck according to claim 8, wherein the ventilation means comprising the ventilation duct is arranged in the clamping part.

10. The hydraulic expansion chuck according to claim 9, wherein the ventilation duct and the pressure duct lie offset to one another by 180° with respect to the rotational or longitudinal central axis.

11. The hydraulic expansion chuck according to claim 1, wherein the hollow shaft is formed as a hollow shaft taper.

12. The hydraulic expansion chuck according to claim 1, wherein the clamping part and the shaft part are formed from separately manufactured bodies.

13. The hydraulic expansion chuck according to claim 12, wherein the clamping part and the shaft part are joined together in a positive manner, non-positive manner and/or by means of a substance-to-substance bond.

14. The hydraulic expansion chuck according to claim 12, wherein the clamping part and/or shaft part are/is formed monolithically.
